(19) United States
(12) Patent Application Publication
(10) Pub. No.: US 2003/0136737 A1
(43) Pub. Date: Jul. 24, 2003

(54) System for separating oil from water

(76) Inventor: Donald R. Glynn, Toronto (CA)

Correspondence Address: Douglas W. Eggins, 129 DAPHNE CRESCENT, BARRIE, ON, L4M 2Y7, CA

(21) Appl. No.: 10/050,712

(22) Filed: Jan. 18, 2002

(51) Int. Cl. B01D 65/02

(52) U.S. Cl. 210/636; 210/650; 210/791; 210/321.69

(57) ABSTRACT

A practicable, compact local system is used to separate emulsified oil from water, enabling re-use or disposal to drain of most of the water. The treated water meets regulatory guidelines for safe disposal to drain. The system can separate highly emulsified oil/water mixes. It uses a ceramic cross-flow membrane filter with pore sizes in the range of 0.005 micron to 1.2 micron, operating at pressures in the range 25 to 150 psi (gauge). Removal of up to about 95% of the water can be achieved. High separation flux rates are achieved by computer controlled cleaning cycles, made practical by providing minimal permeate collection spaces downstream of the filter on the water discharge side. Two independently operable systems may share a modest cabinet.

### STATEMENT REGARDING FEDERALLY SPONSORED RESEARCH OR DEVELOPMENT

Not Applicable

### CROSS REFERENCE TO RELATED APPLICATIONS

Not Applicable

### REFERENCE TO MICROFICHE APPENDIX

Not Applicable

### BACKGROUND OF THE INVENTION

1. This invention is directed to a system comprising a method and apparatus for separating oil and water. In particular, the system is directed to the separation of machining cutting coolant oils, die release agents, oily wash waters, and other emulsified oils from water.

2. Metaphorically speaking, oil and water do not mix. But in practice, their separation is a major problem.

In addition to intentionally created oil/water emulsions such as cutting coolants, industry uses oil for lubrication and water for cooling, etc in a number of processes, and when the two fluids become mixed, they are both effectively contaminated.

It is thought that a reasonable estimate of such contaminated fluid would be 10 billion litres per year for North America.

Probably more than two thirds of this volume is trucked away to be treated off site at centralized treatment plants, the rest being treated on the site where it is generated.

When “coolant” is referred to, in terms of machining cutting coolant, this usually arrives at the machinist's shop in drums of oil concentrate, to be mixed with water to make a ‘working solution’. This may typically be 1% coolant oil concentrate, which forms sub micron oil droplets when mixed with water at 99% by volume.

The problem of dealing with spent cutting coolants and other oil contaminated waters is presently solved in many instances by shipping comparatively large quantities of contaminated water by truck to a distant processing plant. There is a considerable cost for the haulage as well as the subsequent treatment of the oily waters.

There is presently developing a global realization of the widespread nature of water contamination.

Consequent government regulations concerning the handling and disposal of oil-contaminated water also presents problems, both practical and managerial.

Existing known separation processes include: use of absorbent activated clay, to entrain the oily content; chemical emulsion break plants, for chemically breaking down oil/water emulsions; evaporation technologies relying on differences in boiling point to effect selective evaporation; use of adsorbent and absorbent materials, such as adsorbent carbons (including charcoals); as well as systems that use cross flow membrane technologies.

In the case of the absorbent clay, the systems are bulky, expensive, messy, and difficult to maintain to specification. These systems require the services of an attendant, and are considered impractical for waste water volumes below 4-million litres per year.

Chemical de-emulsification plants are very costly, requiring a large floor area, and the services of an operator. In addition to the supply of necessary chemicals, the process also requires considerable energy by way of heat if breaking a chemical emulsion such as machining coolant. Minimum volumes of about 3-4 million litres per annum are desirable, in order to achieve plant efficiency.

Evaporation technologies require the provision of evaporator tanks, and include heating the total volume of liquid to the vapor point of water, and require a large working area.

The surfactant present in cutting coolants, when heated in an evaporator, gives off a soapy smell. Also there is no water recovery unless the plant includes a condenser, at considerable capital cost.

The evaporator tank requires periodic cleaning, with consequent area contamination with oil and coagulants, in and about the work area.

Chemical polymeric treatments are practicable for certain classes of oily waters. However, in the case of cutting coolants, due to the high degree of chemical emulsification of the oil, the mixed fluid is not practically responsive to the chemistry of cationic polymer water treatment.

Cross flow membrane filters are effective, in that the two separated fluids are ultimately recovered.

However, the filter membranes suffer from fouling problems, in which the filtering efficiency is greatly diminished, while cleaning of the membrane is both time consuming and difficult,

The fouling aspect of filter membrane surfaces used for treating waste waters is possibly the single most reputation-damaging aspect of the technology.

In larger systems such modules frequently contain a nest of filter elements within a metal cylinder of significant fluid capacity, as much as 200 liters, thus making impractical the use of an in-situ back-wash chemical cleaning regime, in view of the large volume of cleaning chemicals required to fill such a vessel.

### SUMMARY OF THE INVENTION

The present invention provides a practical, compact local system for separating emulsified oil from water, to the extent of enabling treated water to be drained to sewer on an on-going basis. The treated water usually meets regulatory guidelines and thus can be safely put down the drain in the case of water removed from most oily water emulsions.

The subject system is effective for either highly emulsified oil/water mixes or simpler mechanical emulsions.

The filter of the present invention uses a ceramic cross-flow membrane filter of membrane pore sizes in the range of 0.005 micron to 1.2 micron. Other pore sizes may be selected for other liquids.

Operating pressures may be in the range 25 to 150 psi (gauge).

The subject ceramic filter consists of a sintered ceramic tube composed of aluminum oxide that acts as the support matrix for the ceramic membrane coatings that do the actual “work” of separation. This aluminum oxide matrix is of relatively coarse structure when compared to the ceramic membrane coating that is fused to it internally.

Running the length of the ceramic element (tube) in arrays of rings concentric with its center, are lumens (open channels) through which the oily waste water flows at high velocity.

It is upon the walls of these lumens that the actual ceramic (filtering) membrane is bonded by a sintering process. These sintered membranes typically are composed of aluminum oxide, titanium oxide, or zirconium oxide.

The filter tube is mounted coaxially within a metal cylinder (filter housing), having a predetermined radial clearance from the metal cylinder to form an annular permeate collector space of limited volume about the filter tube.

The ceramic filter element (held by way of O-rings at either end) within its housing together constitute the filter “module”, which is inserted into the piping of the filter process system.

The thus formed filter module has end-fittings (unions, flanges, etc) to permit ready removal and replacement from the process circuit.

Oil contaminated water, which may include other families of contaminants such as metal particles, soap scum etc is referred to hereinafter as waste water.

For normal filtering operation the waste water is pumped axially through the filter tube at a predetermined minimum velocity of about six meters per second, and at elevated pressure, as a cross-flow in relation to the membrane surface, which enables radial permeation of water outwardly, at right angles to the cross flow, as a flow into and through the wall of the filter element.

The high cross-flow velocity serves to diminish the tendency of contaminants present in the waste water from adhering to or passing into the wall of the filter tube.

The thus separated water permeate fills the annular permeate collector space of the filter module, and is led off to drain, or for recycle use.

When shutting down the system, upon the termination of pumping of the waste water in the processing loop or processing ring an instantaneous back pressure is immediately applied to the permeate water, which pulses it back, radially inwardly through the filter wall, as a back-wash, in a direction reverse to its normal (outward) flow, so as to substantially prevent surface contamination of the filter from the core of slowing or stationary waste water of the processing loop.

In any “Power off” situation the pump ceases operation and terminates the high velocity cross-flow motion of the waste water across the surface of the ceramic membrane, which cross-flow normally keeps the membrane from fouling.

The immediate application of an instantaneous back pulse of permeate water into the permeate space of the module protects the membrane surfaces, located internally within the filter, against fouling.

This back pulse is achieved by the opening operation of a valve that connects the permeate space with a reservoir of clean or permeate water, stored under air pressure.

During normal system operation, this biassed-open solenoid valve is held in the closed condition by energizing it along with the rest of the operating equipment.

When de-energised at power-off, the valve snaps open to connect the reservoir of permeate water to the permeate space, into which the water is driven by pressurized air.

In some instances the reverse pulse of permeate water may even dislodge some infiltrated deliterious substances inwardly, from off the filter body.

For cleaning the filter of infiltrated corruption, which may include oil, soap scum and other particulate matter carried in the waste water, cleaning solutions may be applied in-situ, without removing the filter module from the circuit.

These cleaning solutions may include chemicals selected from: sulfuric acid, citric acid, nitric acid, alkaline metal cleaning detergents, hydrogen peroxide, and sodium hydroxide.

In a first cleaning procedure, with the system re-circulation pumps still running, a predetermined quantity of a cleaning chemical solution may be supplied under pressure to the permeate collector space, to form an interface with the permeate contents, and to displace substantially only the collector permeate contents to the waste tank, by way of coordinated operation of a permeate space dump valve.

The predetermined quantity of cleaning chemical is selected to just fill the collector space.

The temperature of the module may then be raised quite rapidly by the simple expedient of continuously recirculating the waste water in a limited closed circuit that includes passage through the filter tube. This action then raises the temperature of the chemical cleaning solution, thereby facilitating its operation in cleaning the pores of the filter.

The chemical cleaning solution may comprise mutually compatible chemicals that do not adversely affect the respective individual chemical activity of the solution's other chemical constituents.

Otherwise, non-compatible cleaning chemicals may be admitted individually to the filter module, and used in isolation.

The warmed cleaning fluid may be pulsed, to enhance its cleaning action and to promote its penetration through the wall of the filter element to eventually reach the innermost membrane surfaces. Such pulsing may be provided by bursts of compressed air driving the cleaning chemical solutions reversely, radially inwardly into the filter.

Tap water is used after a cleaning cycle is completed, to flush off cleaning chemicals from the module permeate space to the waste storage tank.

The permeate collector space and associated connected passages may then be, and preferably are, flushed clean with rinse water, which also is discarded to the waste storage tank.

The radial clearances provided between the ceramic filter element and the cylindrical module housing within which it is enclosed are kept to a minimum, such that the volume of the annular permeate collector space is minimized. This in turn minimizes the repective volumes of cleaning solution and rinse water required for a cleaning cycle, thus making it economically feasible to program frequent and regular cleaning cycles, so as to maintain a consistently high flux rate (the rate of filtering through the module).

Being carried out in-situ, the cleaning cycle or cycles, which may involve more than one cleaning solution, can be programmed into the system controller.

In order to maintain the integrity of the filter module against the applied pressure pulses associated with back-washing and with chemical cleaning cycles, a duplex seal arrangement is provided consisting of two O-ring seals at each end of the filter tube which seal the tube to the filter housing.

A contemplated second (and subsequent) cleaning procedure may consist of:

Terminating the pumping of waste water within the re-circulation loop;

Isolating the filter module from the waste water circuit;

Air-evacuating the processor re-circulation loop by draining waste water from the bottom of the loop, using an air blow-down from the top of the loop;

Filling the re-circulation loop with tap water, followed by air evacuation, as above, to flush out residual waste water and rinse water;

Evacuating the filter module permeate space by using tap water to dispell and flush out the previous cleaning chemical solution from the bottom of the loop;

Continuing a short duration to rinse the permeate space.

A succeeding cleaning cycle may then follow, the succeeding cleaning solution being similarly admitted into the permeate collector space, again displacing the rinse water to the waste tank. The processor re-circulation loop, being full of tap water, is isolated and run long enough to heat up its contents, such heat being transferred to the new chemical solution in the permeate space of the module.

Once heated, the cleaning solution is back-pulsed by applied air pressure, to continue the cleaning of the filter, followed by draining of the solution to the waste tank, with water rinsing of the filter module permeate space.

Before restarting the filtration process, after normal stoppage or after a cleaning cycle, the permeate space may first be filled with clean water, and the permeate collector space pressurized to cause backflow through the filter. This creates a thin film of water, or a reverse flow tendency, in protective relation over the radially inner surface of the filter element prior to resuming recirculation of waste water through the filter.

Once the processor main pumps re-start and re-circulation loop velocity is re-established, this back-pressure safety is no longer needed, and is terminated, as the waste water now has the requisite cross-flow velocity necessary to substantially obviate surface fouling.

The filter is operated in a fashion to maintain the requisite operating and flow conditions that promote self-cleaning, so as to minimize surface fouling of the filter, primarily by control of system pressure and the flow velocity through the filter module.

With the filter in operation it has been found that the increasing percentage of oil in the recirculating waste water or retentate should not exceed a predetermined percentage concentration, as operation with a recirculated retentate of higher oil content than about 40 percent can promote fouling of the filter radially inner, primary flow surface, along which the retentate flows.

Flux rates also drop off dramatically under a high oil ratio in the retentate.

It should be appreciated that concentration from a typical, initial 2% to a final 40% oil content is equivalent to the separation and reclamation (or disposal to drain) of 95% of the original water content.

When the system is operating in its normal mode, an incoming contaminated oil/water mixture is first screened for major foreign bodies, such as metal shavings, rust, dirt, and the like.

The filter may be operated as a continuous flow process, such that the incoming sides of the lumens in the filter element or elements are being substantially continuously flushed across its surface by recirculating oily water, which delays or prevents the surface becoming plugged with small oil droplets or other debris.

The products of the filter, namely filtered water and concentrated oily waste (retentate) pass to respective holding tanks for disposal, the permeate having exited through the walls of the filter element, and the concentrated oily retentate through a solenoid valve that drains the process loop on a predetermined schedule.

The concentrated oily waste, having a concentration of up to about 40% oil in emulsion, is removed for disposal or further treated on site to drop out the water from this emulsion to be returned to the process.

This quantity requiring disposal usually represents significantly less than 10% of the original raw feed liquid, even as little as 2-5% of the original feed quantity when after-processing emulsion breaking activities are carried on.

The system includes a multi-port manifold, the individual ports each having a solenoid valve for controlling the open or closed state for the port by way of a bang-bang (on/off) control.

The operation of the process is separated into discrete system functions, enabling it to be readily controlled by a central computerized control.

This controller can then control a number of such processing systems.

Individual filter modules of the multiple systems may filter different waste liquids, using respective processor loops. The different loops may all be controlled by the same logic controller and associated fluid manifold systems.

The subject processor's filter loop is very compact with an embodiment in a substantially planar arrangement. This enables the total system to be installed within a modest sized cabinet.

In one embodiment, the cabinet has a compact computerized control system which controls the system pumps as well as the manifold mounted solenoids, the manifold being mounted within the interior of the processor loop compartment.

The filter loop system is pivotally mounted, for rotational diplacement within the cabinet, to facilitate access and servicing of the system and its components, when rotated.

A second, parallel system that requires no additional space can be similarly mounted within the same cabinet compartment, to the same effect, the modules being arranged in back-to-back relation and being controlled by the same controller.

By mounting the two processing loops and modules on a vertical pivot, and with the provision of flexible connection hoses, either processing loop can be readily accessed from the front of the cabinet, for servicing purposes.

Despite the compactness of the system, a good rate of permeate flow can be achieved.

In a test plant having a module with a membrane surface area of 0.2 square meters a daily permeate flow rate of about 1200 liters per day was achieved consistently, operating with a program of three cleaning cycles per day The waste material being treated was a mixture of cutting coolants, floor wash, pressate fluids, and tumbler wastes with an average oil content of 2.5%. This processing output represents a flux rate of 6000 liters of permeate per day per square meter of membrane surface area.

For a module having a filtration element of 0.4 square meters, a daily permeate output well in excess of 2000 liters is anticipated.

While the present process is particularly directed to the separation of oil and water, it will be understood that it may well be applied to other liquid media separation.

### BRIEF DESCRIPTION OF THE DRAWINGS

Certain embodiments of the invention are described by way of illustration, without limitation thereto other than as set forth in the accompanying claims, reference being made to the accompanying drawings, wherein:

FIG. 1 is a schematic diagram in frontal elevation of a system embodiment of the processing filter loop in accordance with the present invention;

FIG. 2 is a schematic diagram of the FIG. 1 embodiment, together with the associated service connections, illustrated as operating in a No Power phase of its cycle;

FIG. 3 is a plan view of a cabinet (top removed) enclosing two filtration systems in accordance with the present invention.

FIG. 4 is similar to FIG. 3, with the cabinet door in the open condition;

FIG. 5 is a diametrical cross-section of the end portion of a cross flow membrane filter module in accordance with the present invention.

FIGS. 6 through 11 are schematic process connections for operation of the FIG. 1 embodiment, under separation phase and cleaning phase operating conditions; and

FIGS. 12-16 are schematic process flow charts for the FIG. 1 embodiment.

### DETAILED DESCRIPTION OF THE INVENTION

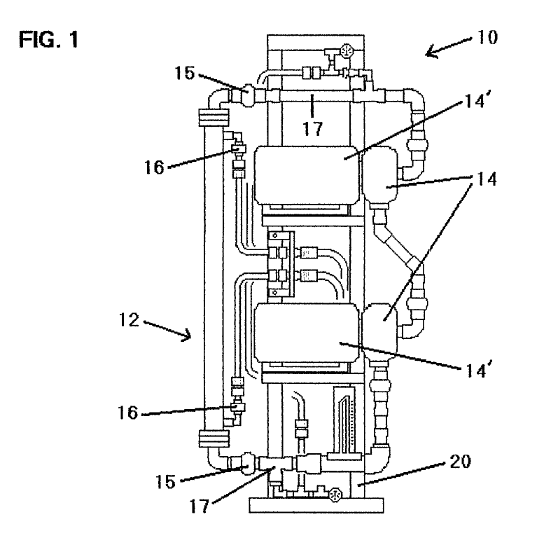

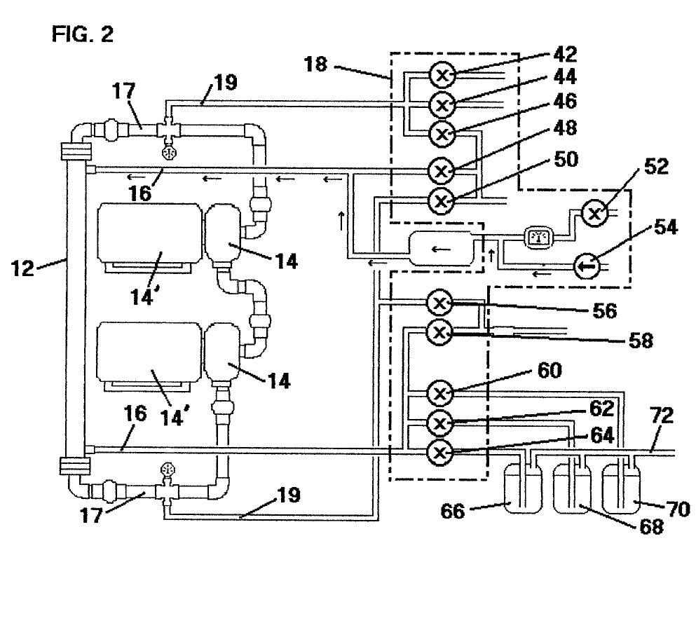

Referring to FIGS. 1 and 2, a separation system 10 in accordance with the present invention, representing only the processing filter loop (and excepting the programmable logic controller, solenoid manifold, chemical solution tanks, etc.) has a separation filter module 12 connected in series relation with two circulating pumps 14, 14, driven by electric motors 14′. The pumps 14, 14 circulate the raw oil/water mix in a closed circuit by way of pipelines 17.

A pair of unions 15, 15 in the circulation pipelines 17 provide disconnection capability, to enable replacement of the filter module 12, when required.

Permeate circuit connections 16, 16 (FIG. 2) from the top and the bottom of the filter module 12 connect with a distribution manifold 18. As well, top and bottom processor loop connections connect with manifold 18.

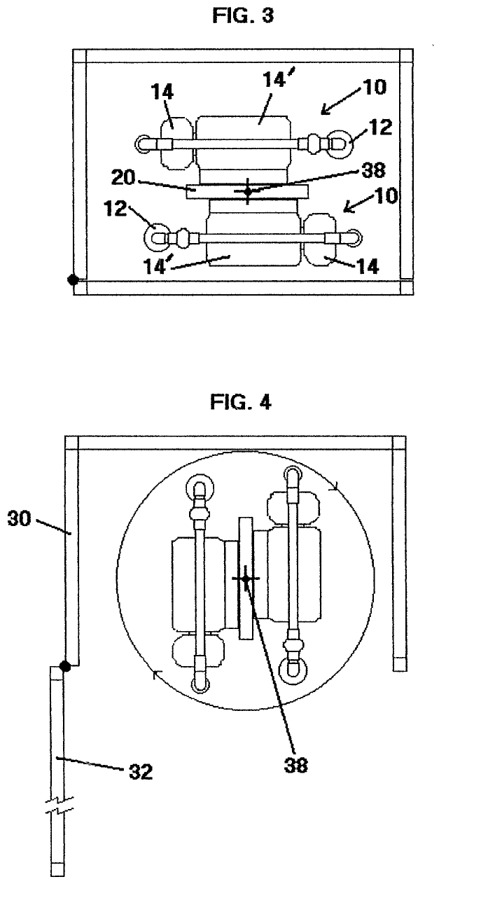

Referring also to FIGS. 3 and 4, the system elements are mounted as planar assemblies each upon a planar vertical frame 20. In FIGS. 3 and 4, two such systems 10 are mounted in back-to-back relation within a cabinet 30. All the components of the two systems may be advantageously mounted within a single cabinet.

The two systems 10 are mounted upon a vertical-axis pivot 38, such that one or other of the systems 10 can be exposed for ready access through the open door 32 of the cabinet 30. The raw water and other connections are by way of flexible extended hoses (not shown), such that either of the systems 10 can be readily accessed.

In FIG. 4, the two systems are shown in course of being reversed, having been rotated 90 degrees clockwise.

Referring back to FIG. 2, a manifold 18 is delineated by way of phantom lines, including therewith the associated solenoid-controlled valves 42 through 64, that serve the respective fluid connections.

The illustrated valve conditions are for a No Power condition, such as the switching off of the pumps 14. Valve 44 and Valve 54 connect to a common air supply (not shown).

Three cleaning solution tanks 66, 68 and 70 are shown. It will be understood that more or less tanks may be required, depending on the nature of the raw oily feed water.

The three cleaning solution (“Chem”) tanks 66, 68, and 70 are pressured up from the common air supply (not shown).

The fluid connections for the respective valves 42 through 64 are as follows: 42—raw oily feed water supply, 44—air for purging; 46—purged air/water; 48—purge cleaning solutions; 50—common purge valve (i.e. for purge air, water, & chemical cleaning solutions, all purge lines leave the processor here); 52—permeate out; 54—normally open air safety valve; 56—tap water; 58—tap water for purging solutions; 60, 62, 64—respective cleaning solutions, from tanks 66, 68, 70. 60 (66)=detergents; 62 (68)=acids; 64 (70)=spare, alternative chemicals. In operation:

Valve 42: Introduces waste oily water to the system for processing.

Valve 44: This valve is connected to a source of compressed air. When the processing loop needs to be evacuated of waste water this valve opens supplying air to the top of the loop which drives water out of the loop through the bottom and out through valve 50 and on to the waste holding tank.

Valve 46: When the processing loop is empty of any water and is being filled with either tap water or waste water, air (and a small amount of water) escapes through valve 46 to the waste holding tank. Escaping air allows the process loop to fill.

Valve 48: After each cleaning cycle, any cleaning solution that remains is removed from the module's permeate space by a flush of tap water introduced through valve 58. Water from valve 58 travels through the permeate space of the filter module, entering at the bottom and exiting at the top before flowing through valve 48 and on to the waste holding tank.

The motion of this water can be used either to push cleaning solutions from the module after cleaning, or as a tap water flush of the module before the introduction of a succeeding cleaning chemical.

Valve 50: Water from the bottom of the process loop leaves through valve 50 to the waste tank after valve 44 opens to introduce pressurized air to the top of the loop, which ultimately drives the water out of the loop through valve 50 and on to the waste holding tank.

Valve 56: This valve introduces tap water to the process loop from the bottom. This is done to fill the loop with water before start up or alternately to fill the loop during a flushing sequence of a chemical cleaning cycle.

Valve 58: This valve admits tap water into the bottom of the module to drive excess cleaning solution out the top of the module, to exit through valve 48. The valve 58 also opens to flush the module's permeate space clean of left over chemistry after a cleaning cycle.

Valve 60: This valve introduces cleaning chemical solution number 1 into the permeate space of the module. Tank 66 is air pressurized.

Valve 62:_This valve introduces cleaning chemical solution number 2 into the permeate space of the module. Tank 68 is air pressurized.

Valve 64: This valve introduces cleaning chemical solution number 3 into the permeate space of the module. Tank 70 is air pressurized.

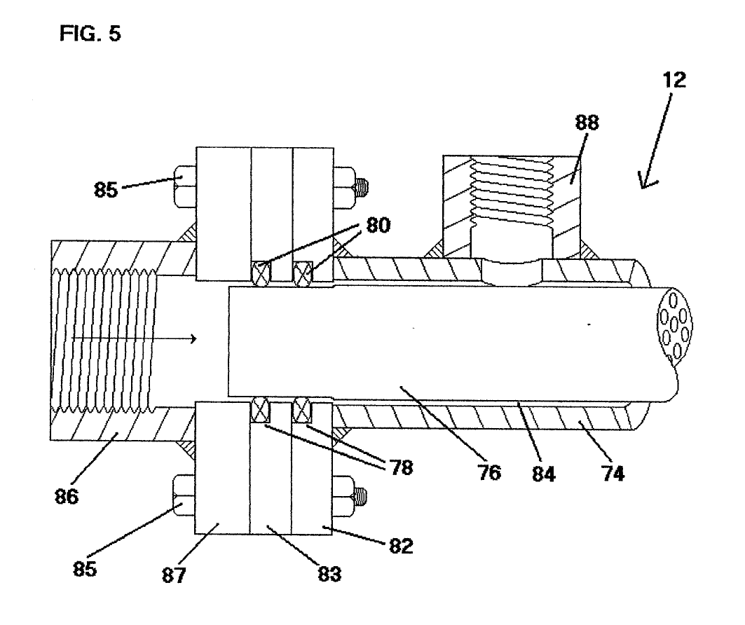

Referring to FIG. 5, a lower portion of a filter module 12 has a cylindrical metal housing 74 with a cylindrical ceramic filter element 76 supported by way of a duplex O-ring seals 80, 80. The O-ring seals 80, 80 are held in place by way of machined out shoulders 78, 78 cut into flanges 82, 83. Flange 82 is welded to the cylindrical metal housing 74. Flange 86 is a flat flange which pulls the whole assembly up when the bolts 85, 85 (plus two more not shown) are tightened.

The annular permeate space 84 between the filter element 76 and the housing 74 receives the permeate water that has passed through the wall of filter element 76.

An end connector 86 connects the filter module 12 to the waste water circulation pipeline 17 (FIG. 2); and a connector 88 welded to the wall of housing 74 connects the permeate space 84 with the manifold 18 (FIG. 2).

The permeate space 84 is kept to a minimum volume, to minimize the quantities of cleaning fluid required to fill it, as in a back-flushing cleaning operation.

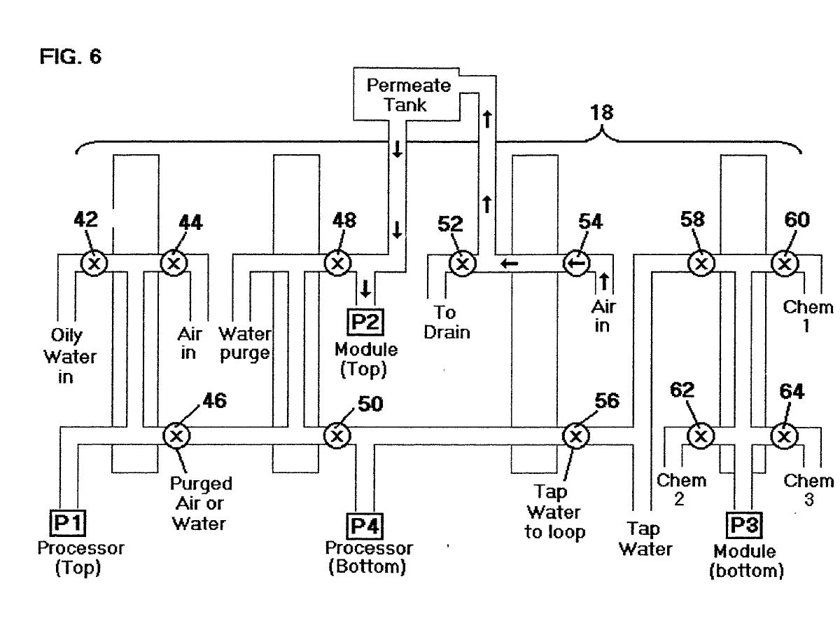

Referring to FIG. 6, this shows the state of the system for a Power Off or a Power Failure condition, as exemplified by the respective open or closed condition of the flow control valves 42 through 64, which connect with manifold 18, shown schematically.

The manifold 18 is machined from suitable brass bar stock and acts as both the support for the solenoids as well as providing the appropriate routing connections between the various fluid lines that are controlled by the solenoids.

Basically, despite the complexity of the manifold, with lines coming in from outside the processor, or leaving the processor, only four lines actually connect the manifold to the process loop and module. Therefore only those four lines require the added length and flexibility to permit axial rotatation when the processor is in service or the “Back Processor” is rotated to the front of the cabinet for servicing.

In FIGS. 6-11 the boxed designations P1, P2, P3, and P4 refer to these four points of external connection on the processor proper.

The control valves are all solenoid actuated, operating in bang-bang mode, i.e. being in either a fully open or a fully closed condition, as controlled by the computerized controller.

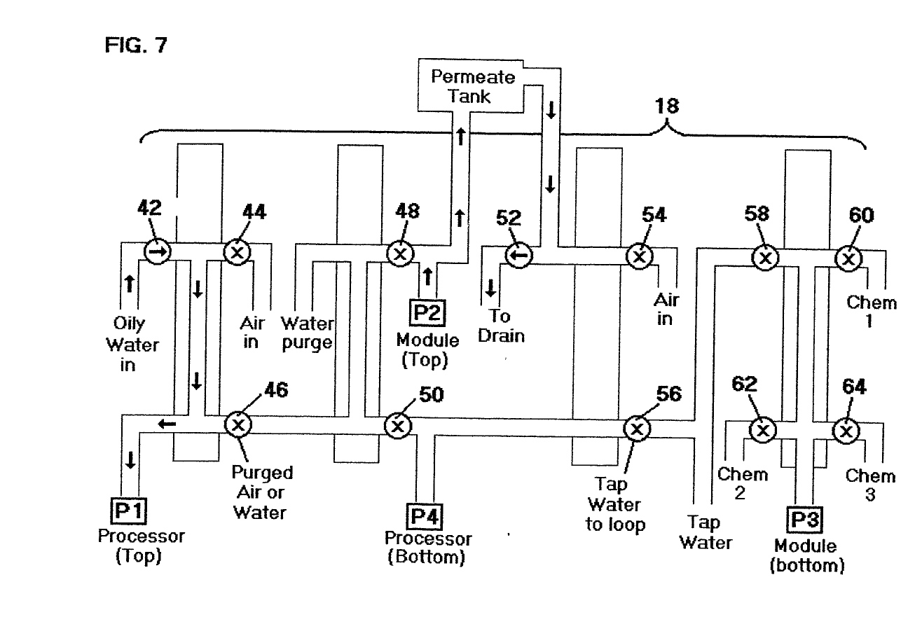

FIG. 7 shows the respective conditions of the manifold valves during normal processing.

FIG. 8 shows the respective valve settings during the discharge of a portion of the recirculating, concentrated oily water (retentate) from the process loop. The delineation of manifold 18, shown in FIGS. 6 and 7, has been omitted from FIGS. 8-11.

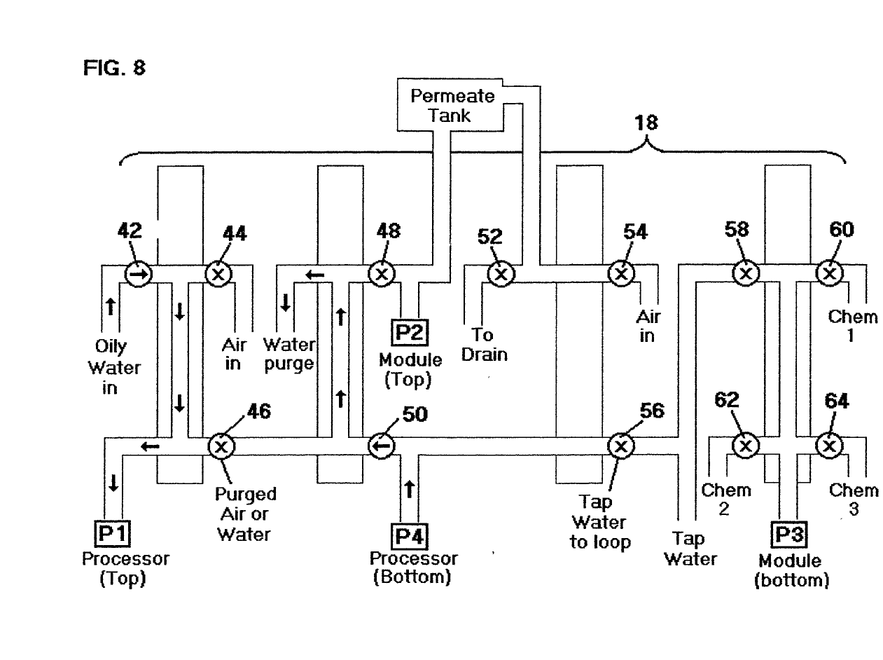

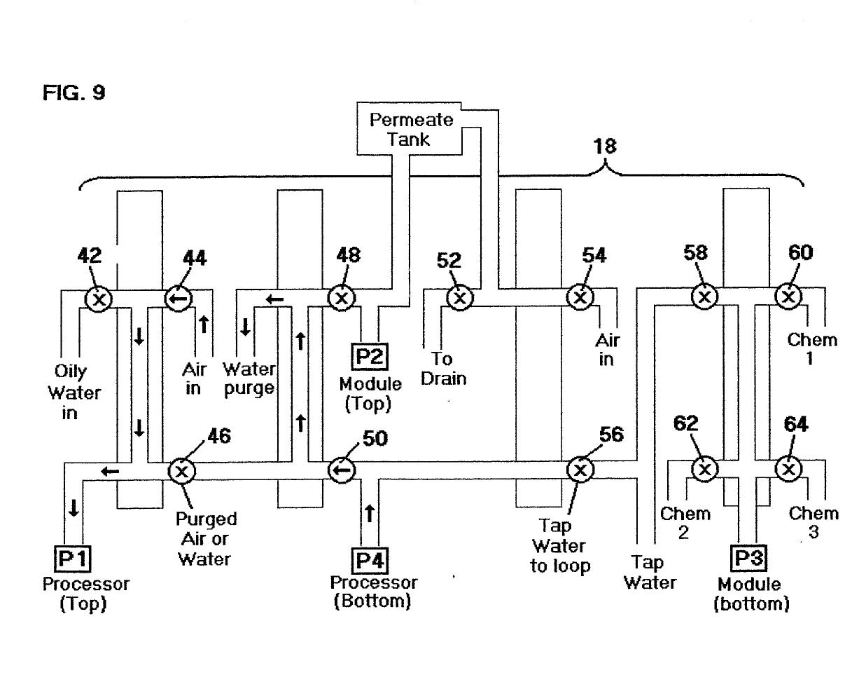

FIG. 9 shows the respective manifold valve settings for the admission of purge air to effect discharge of oily water from the process circulatory loop.

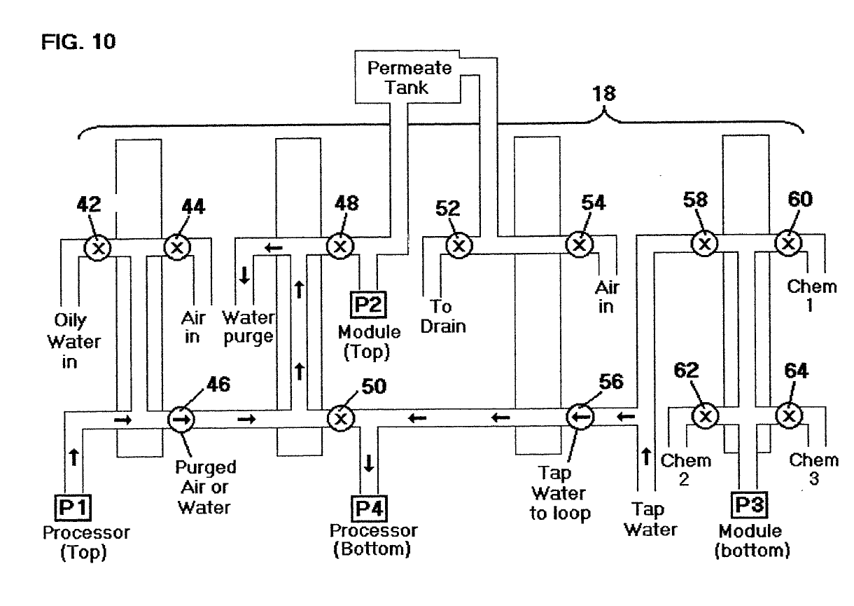

FIG. 10 shows the respective valve settings for effecting flushing of the process circulatory loop with tap water.

FIG. 11 shows the respective valve settings for effecting a tap water flush after a chemical back-flush cleaning cycle through the permeate collection circuit.

The subject system takes relatively little floor area.

In operation, the normal cycle commences with the admission of the raw feed typically by way of an air diaphragm pump (not shown), the raw feed being a mixture of water and oil emulsion, usually having a concentration of oil of about 1-2 percent. The raw feed is passed through a sieve, to remove coarse particles, including foreign objects such as rags. This sieve can be readily cleaned without interruption of the cycle of operations. The air diaphragm pump also moves water into the process loop, and applies static pressure on the system.

The oil/water retentate mixture, being concentrated in the process by the removal of up to 95 percent of the water, is then about a 40 percent oil/water mixture, which is well suited for haulage, storage and ultimate disposal, or for further concentration.

Concerning the filter element 76, which has membrane pore sizes in the range 0.005-1.2 microns, the selection of pore size is based upon its appropriateness for the aqueous waste mix involved.

_Turning to FIGS. 6 through 11, FIG. 6 shows the state of the respective valves when power is switched off, or there is a power failure. The system is set up such that all valves except one will close in the absence of power, effectively shutting off all air or fluid movement to or from the processor. During a power off situation the only valve left in an open state is the air pressure safety valve. This is the only “Normally Open” valve in the system. When the processor is powered up, this valve closes and is held closed until there is an absence of power. With no power all other valves close, but this one now opens to receive compressed air, to drive processed permeate water backwards into the permeate space of the module. This pressurized water pushes through the filter element flowing through and protecting the membrane filter surface.

FIG. 7 shows the system component condition for normal processing.

FIG. 8 shows the system component condition when purging some of the concentrated retentate (oily waste water) from the processing loop, for subsequent disposal.

FIG. 9 shows the system component condition for admitting purging air, when purging the processing loop of retentate (oily water).

FIG. 10 shows the system component condition when flushing the process loop with tap water;

FIG. 11 shows the system condition when flushing with tap water after a chemical cleaning cycle; and,

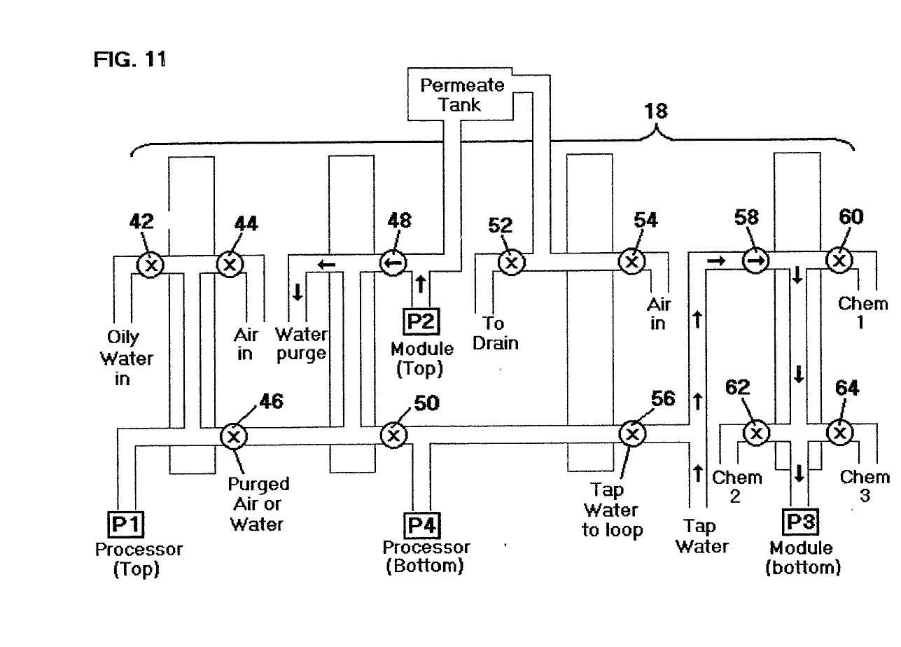

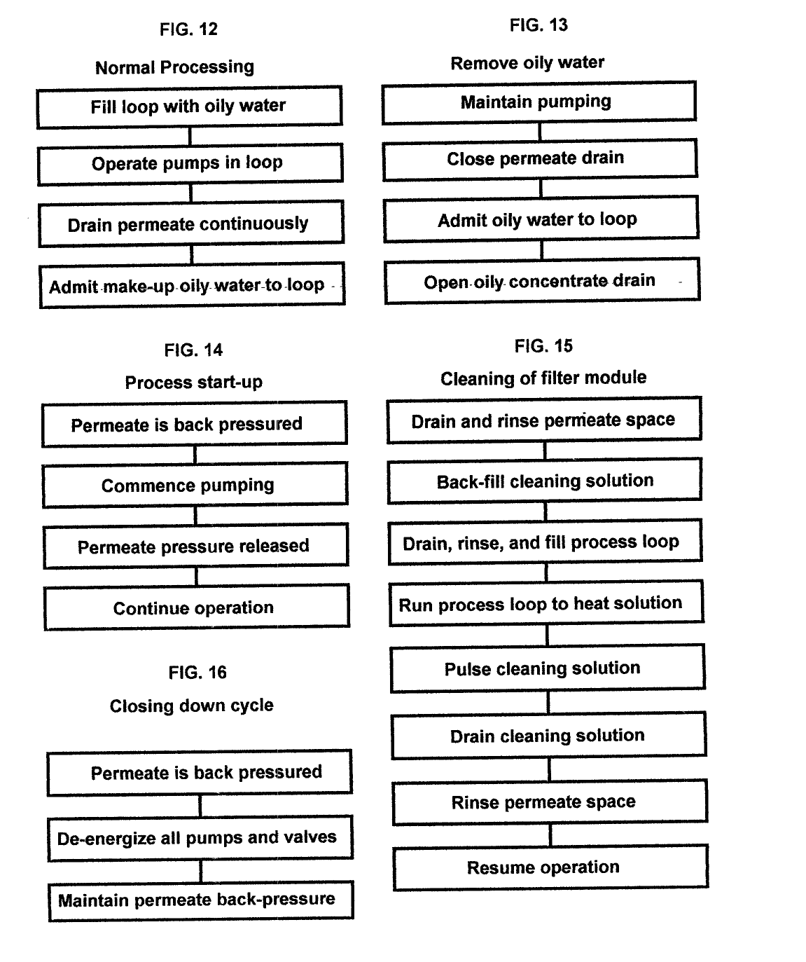

FIGS. 12 through 16 show the operating modes for the subject process.

1. A process for treating a polluted liquid having at least one contaminant in intimate mixed relation therein, including the steps of passing the polluted liquid under pressure through a cross-flow filter module having a filter with a series of lumens having filter membranes extending substantially parallel with the flow of said polluted liquid; maintaining the flow at a predetermined minimum velocity to substantially sustain scouring of the surface of said membrane by said liquid; maintaining said pressure to induce passage of said liquid as a permeate in a substantially unpolluted, filtered condition through said filter membrane into a permeate space, wherein the concentration of said contaminant in said polluted liquid is progressively increased; applying a pressure back-pulse to said filtered liquid in said permeate space to reverse flow through said filter membrane, in at least partial cleaning relation therewith, and collecting said polluted liquid and said filtered liquid for disposal.

2. The process as set forth in claim 1, including the step of introducing a cleaning solution in place of said permeate liquid; and back-flushing said filter membrane with said solution to at least partially remove a said contaminant therefrom.

3. The process as set forth in claim 2, including draining said cleaning solution from said module; and continuing to pass said polluted liquid through said module.

4. The process as set forth in claim 1, including back-flushing said permeate to substantially cover said membrane, prior to applying said pressure to said polluted liquid.

5. The process as set forth in claim 2, including the step of heating said cleaning solution, to promote the effectiveness thereof.

6. The process as set forth in claim 5, including the step of recirculating said contaminated liquid in a closed circuit, to raise the temperature thereof, whereby the temperature of said module and said cleaning solution are raised, to promote the cleaning action of said cleaning solution.

7. The process as set forth in claim 2, wherein said polluted liquid is water and said contaminant is oil, said cleaning solution being selected from the group consisting of citric acid, nitric acid, non-caustic alkaline low-foam metal cleaning detergent, hydrogen peroxide, sodium hydroxide, and mutually compatible combinations thereof.

8. The process as set forth in claim 2, said cleaning solution being a mixture of a plurality of mutually compatible cleaning solutions.

9. The process as set forth in claim 2, wherein said filter module is operated cyclically, with a period when said polluted liquid is circulated through said module and said permeate is removed from the module being followed by a period when at least one said cleaning solution is applied to said filter in situ, in cleaning relation therewith.

10. The process as set forth in claim 9, wherein said process is automatically cycled to include periods of filtration activity, periods of cleaning, and quiescent periods, said periods being programmed to provide a desired rate of filtering operation.

11. The process as set forth in claim 2, wherein said permeate space is minimized, to effectively minimize the quantity of said cleaning solution required to fill said permeate space, whereby said step of introducing said cleaning solution may be repeatedly and economically applied.

12. Apparatus for retrieving re-usable water from an intimate water/oil—contaminated mixture, said apparatus having a cross-flow filter module to permit the passage of substantially oil-free water as a permeate through the filter module; pumping means to circulate said contaminated mixture through said module at a predetermined flow rate sufficient to substantially resist deposition of contaminants and to scour a surface membrane portion of said filter module; and permeate accumulation and drain means to receive said permeate for disposal, wherein, in use the concentration of oil within said contaminated mixture is progressively increased to a predetermined optimum practical limit.

13. The apparatus as set forth in claim 12, including cleaning solution storage means, manifold means interconnecting elements of said apparatus; and control means including solenoid actuated valves connected with said apparatus elements and said manifold means, in use to drain said permeate from said module, and to admit cleaning solution from said storage means to said module in back-flushing relation with said surface membrane portion of the module.

14. The apparatus as set forth in claim 12, said filter module having a central tube incorporating said surface membrane portion, an outer housing in radially spaced relation from said tube, forming an annular space therebetween, sealing ring means located adjacent the ends of said central tube in interposed sealing, supporting relation between said tube and said pipe, and an end fitting secured in sealing relation with the end of said housing to enable the flow of said contaminated mixture through said end fitting and into said tube.

15. The apparatus as set forth in claim 14, said sealing ring means at each end of said tube having two O-ring seals in mutual axially spaced relation.

16. The apparatus as set forth in claim 12, including compressed air means connected to said permeate accumulation means, and control means to admit compressed air in compressing relation with said permeate, in use to create a back-flushing motion of said permeate through said filter surface membrane.

17. The apparatus as set forth in claim 13, wherein said apparatus is mounted within a cabinet, including computerized control means in programmed controlling relation with the apparatus.

18. The apparatus as set forth in claim 17, wherein said cabinet contains two said processing loops mounted in back-to-back relation, and pivot means enabling the reversal of said modules, to facilitate access thereto for purposes of servicing.

19. The apparatus as set forth in claim 17, said computerized control means serving a plurality of said filter modules in individual liquid filtering and filter cleaning modes of operation of the apparatus.

20. The apparatus as set forth in claim 12, said permeate accumulation means having a substantially minimal volume, to minimize the volume of cleaning liquid required to fill said permeate accumulation means, for purposes of cleaning said filter module by back-flushing with said cleaning liquid.
